(19) United States
(12) Patent Application Publication
(10) Pub. No.: US 2012/0067506 A1
(43) Pub. Date: Mar. 22, 2012

(54) FILM PROCESSING EQUIPMENT AND METHOD USING THE SAME

(75) Inventors: Yi-Hun Tan, Taoyuan County (TW); Po-Tung Lai, Taoyuan City (TW); Yi-Hsiu Chen, Pingzhen City (TW)

(73) Assignee: BENQ MATERIALS CORP., Gueishan Township (TW)

(21) Appl. No.: 13/212,031

(22) Filed: Aug. 17, 2011

(30) Foreign Application Priority Data
Sep. 20, 2010 (TW) 99131880

(51) Int. Cl. B32B 37/00; B29C 65/00

(52) U.S. Cl. 156/83; 156/443

(57) ABSTRACT

A film processing equipment and a method for processing a film is provided. A feeding roller feeds the film to a swelling bath and the swelling bath immerses the film. A dyeing bath dyes the film transferred from the swelling bath and a stretching bath stretches the film. The stretching bath comprises three sets of rollers dividing a film transferring path into a first interval length and a second interval length. The first interval length is in an upstream with respect to the film transferring path and smaller than the second interval length. A crosslinking bath performs a crosslinking process on the film transferred from the stretching bath and a washing bath washes the film. A film attaching assembly performs a film attaching process on the film transferred from the washing bath and a winding device winds the film transferred from the film attaching assembly.

This application claims the benefit of Taiwan application Serial No. 99131880, filed Sep. 20, 2010, the subject matter of which is incorporated herein by reference.

### BACKGROUND OF THE DISCLOSURE

1. Field of the Disclosure

The disclosure relates in general to film processing equipments and methods using the same, and more particularly to a film processing equipment using rollers and method using the same.

2. Description of the Related Art

The film, such as a polarizing film used in the liquid crystal display (LCD), has been widely used in people's everydayness nowadays. When the unpolarized light passes through the polarizing film, the polarizing film makes unpolarized light becomes linear polarized light. Thus, a liquid crystal monitor equipped with the polarizing film achieves required colors and light fluxes by operating with a driving voltage to drive the liquid crystals. The trend of the LCD towards large sized panels. The polarizing film is an important element of the LCD and a width and size stability of the polarizing film (that is, low contraction) must be increased. It can increase a material utilization rate and reduce a material consumption of the polarizing film by increasing the width of the polarizing film and reduce a neck-in degree of the polarizing film during a manufacturing process. As a result, a manufacturing cost of the polarizing film is reduced and the profit is increased. Moreover, the increase in the size stability of polarizing film avoids the polarizer being contracted due to heat generated by a backlight source and also avoids a peeling of the polarizing film during a high temperature and humidity reliability test. Therefore, how to increase the width and size stability of polarizing film becomes an imminent task for industries.

### SUMMARY OF THE DISCLOSURE

The disclosure is directed to a method for processing a film and an equipment using the same, and more particularly to a method for processing the film using rollers for transferring and stretching and a film equipment using the same.

According to an aspect of the present disclosure, a film processing equipment includes at least two ovens, a feeding roller, a swelling bath, a dyeing bath, a stretching bath, a crosslinking bath, a washing bath, a film attaching assembly and a winding device is provided. The feeding roller is used for feeding a film. The swelling bath is used for receiving and immersing the film transferred from the feeding roller. The dyeing bath is used for receiving and dyeing the film transferred from the swelling bath. The stretching bath is for receiving and stretching the film transferred from the dyeing bath. The crosslinking bath is used for receiving the film transferred from the stretching bath and crosslinking the film in the crosslinking bath. The washing bath is used for receiving and washing the film transferred from the crosslinking bath. The film attaching assembly is used for receiving the film transferred from the at least one oven and performing a film attaching process on the film. The winding device is used for winding the film. The stretching bath comprises a plurality of sets of rollers disposed at different positions on a film transferred path in the stretching bath, the sets of rollers divide the film transferring path into a first interval length and a second interval length. The first interval length is in an upstream with respect to the film transferring path, the second interval length is in the downstream with respect to the film transferring path, and the first interval length is smaller than the second interval length.

According to another aspect of the present disclosure, a method for processing the film is provided. The method includes:

providing a film processing equipment, which includes a feeding roller, a swelling bath, a dyeing bath, a stretching bath, a crosslinking bath, a washing bath, a film attaching assembly and at least two oven and a winding device;

providing a film on the feeding roller and feeding the film from the feeding roller;

receiving the film transferred from the feeding roller and immersing the film in the swelling bath;

receiving the film transferred from the swelling bath and dyeing the film in the dyeing bath;

receiving the film transferred from the dyeing bath and stretching the film in the stretching bath;

receiving the film transferred from the stretching bath and performing a crosslinking process on the film in the crosslinking bath;

receiving the film transferred from the crosslinking bath and washing the film in the washing bath;

receiving the film transferred from the washing bath and reducing a water content of the film by heat of the at least two ovens;

receiving the film transferred from the one of at least two ovens and performing a film attaching process on the film with the film attaching assembly;

receiving the film transferred from the film attaching assembly and curing the film by heat of the at least two ovens; and

winding the film with the winding device;

wherein the stretching bath comprises a plurality of sets of rollers disposed at different positions on a film transferred path in the stretching bath, the sets of rollers divide the film transferring path into a first interval length and a second interval length, and

wherein the first interval length is in an upstream with respect to the film transferring path, the second interval length is in the downstream with respect to the film transferring path, and the first interval length is smaller than the second interval length.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of one embodiment of a film;

FIG. 2 is a schematic diagram of one embodiment of a film processing equipment;

FIG. 3 is a schematic diagram of one embodiment of a film transferring path and rollers installed in the film processing equipment of FIG. 2; and

FIG. 4 is a flowchart illustrating one embodiment of a method for processing a film.

### DETAILED DESCRIPTION OF THE DISCLOSURE

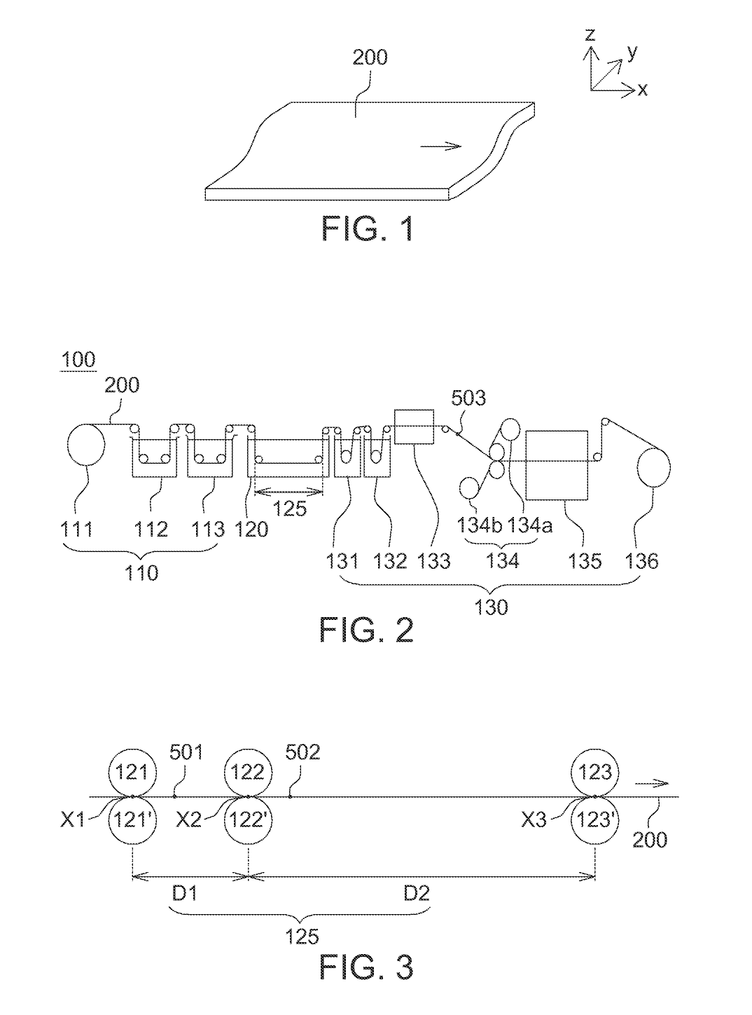

Referring to FIG. 1, a schematic diagram of one embodiment of a film 200 is shown. The film 200 moves in the +x direction of the x-axis. In the embodiment, a film processing equipment 100 and the method for processing the film 200 using the same reduce the neck-in degree of the film 200 during the manufacturing process. The term “neck-in” refers to the width of the film 200 being narrowed during the manufacturing process, that is, the width of the film 200 becomes narrowed in directions of the y-axis of FIG. 1. The neck-in of the film 200 makes a usable area of the film 200 smaller and a utilization rate of the film 200 deteriorated. In another embodiment, the film processing equipment 100 and the method for processing the film 200 using the same decreases a contraction value of the film 200. The term “contraction value” refers to a displacement caused by the contraction in the length of the processed film 200 in the direction of the x-axis of FIG. 1. The displacement of contraction is measured by a size stability quantitative instrument before and after a temperature is increased.

A material of the film 200 can be a polyvinyl alcohol (PVA) film, which is one of the materials for forming the polarizing film. In one embodiment, the polymerization degree of the PVA film is within the range of 500 to 10000. In another embodiment, the polymerization degree of the PVA film is within the range of 1000 to 6000. In one more embodiment, the polymerization degree of the PVA film is within the range of 1400 to 4000.

In one embodiment, a thickness of the PVA film is within the range of 5 um to 150 um. In another embodiment, the thickness of the PVA film is within the range of 10 um to 100 um. In addition, a saponification degree of the PVA film is within the range of 75% to 100%. In another embodiment, the saponification degree of the PVA film is within the range of 97% to 100%. In one more embodiment, the saponification degree of the PVA film saponification degree of the PVA film is within the range of 98.5% to 99.8%.

### First Embodiment

Referring to FIG. 2, a schematic diagram of one embodiment of the film processing equipment 100. The film processing equipment 100 includes a pre-processing module 110, a stretching bath 120 and a post-processing module 130. The pre-processing module 110 performs a pre-process on the film 200. In one embodiment, the pre-processing module 110 includes a feeding roller 111, a swelling bath 112 and a dyeing bath 113. The feeding roller 111 unwinds the film 200 and feeds the film 200. The swelling bath 112, which contains water, receives and immerses the film 200 transferred from the feeding roller 111. The water in the swelling bath 112 washes the dirt off the surface of the film 200 and moisturizes the film 200 to facilitate the subsequent dyeing process.

The dyeing bath 113 receives and dyes the film 200 from the swelling bath 112. The dyeing bath 113 contains iodine, potassium iodide and boric acid, and receives the film 200 transferred from the swelling bath 112. Since the film 200 transferred from the swelling bath 112 contains water, the iodine contained in the dyeing bath 113 will be diffused over the film 200 after the film 200 is transferred to the dyeing bath 113 to dye. In one embodiment, a content of iodine in the dyeing bath 113 is within the range of 0.01% to 0.5% by weight. In another embodiment, the content of iodine in the dyeing bath 113 is within the range of 0.05% to 0.4% by weight. In one more embodiment, the content of iodine in the dyeing bath 113 is within the range of 0.1% to 0.3% by weight. In one embodiment, the content of potassium iodide in the dyeing bath 113 is within the range of 0.05% to 50% by weight. In another embodiment, the content of potassium iodide in the dyeing bath 113 is within the range of 0.25% to 40% by weight. In one more embodiment, the content of potassium iodide in the dyeing bath 113 is within the range of 5% to 30% by weight. In one embodiment, the content of boric acid in the dyeing bath 113 is within the range of 0.2% to 2.4% by weight. In another embodiment, the content of boric acid is within the range of 0.2% to 1.2% by weight. In one more embodiment, the content of boric acid is within the range of 0.2% to 0.6% by weight. In one embodiment, the temperature in the dyeing bath 113 is within the range of 10° C. to 60° C. In another embodiment, the temperature in the dyeing bath 113 is within the range of 20° C. to 50° C. In one more embodiment, the temperature in the dyeing bath 113 is within the range of 30° C. to 40° C. In practical application, the actual contents of iodine, potassium iodide and boric acid and the temperature in the dyeing bath 113 can be adjusted according to actual needs in the manufacturing process.

The stretching bath 120 receives and stretches the film 200 transferred from the dyeing bath 113 of the pre-processing module 110. The stretching bath 120 includes a plurality of sets of rollers. The rollers respectively dispose at different positions in a film transferring path 125 of the stretching bath 120. The sets of rollers divide the film transferring path 125 into several intervals. As shown in FIG. 3, the number of sets of rollers on the film transferring path 125 is 3. In the embodiment, each pair of rollers includes two rollers respectively located on two sides of the film transferring path 125. The film 200 contacts rollers 121 and 121′, rollers 122 and 122′ and rollers 123 and 123′ in sequence. Wherein, the rollers 121 and 121′, the rollers 122 and 122′ and the rollers 123 and 123′ respectively disposes at positions X1, X2 and X3 in the film transferring path 125. The rollers 121 and 121′, the rollers 122 and 122′ and the rollers 123 and 123′ respectively divide an interval D1 between the position X1 and the position X2 and an interval D2 between the position X2 and the position X3. Wherein the interval D1 is in an upstream (closer to the pre-processing module 110) with respect to the film transferring path 125. In addition, the interval D2 is in a downstream (closer to the post-processing module 130) with respect to the film transferring path 125.

In one embodiment, a rotation speed of the rollers 121 and 121′ is different from the rotation speed of the rollers 122 and 122′, a rotation speed difference exists. After the film 200 passes through the interval D1 between the rollers 121 and 121′ and the rollers 122 and 122′, the longer the film 200 will be stretched in the direction of the x-axis of FIG. 1 if the larger the rotation speed differences. A quotient of the length of the film 200 after passing through the interval D1 divided by the length of the film 200 before passing through the interval D1 is defined as a drawing ratio of interval D1. For example, if the drawing ratio of interval D1 equals 1.47, this means that the length of the film 200 after passing through the interval D1 is 1.47 times of the length of the film 200 before passing through the interval D1. The definition of the drawing ratio of interval D2 is similar to the definition of the drawing ratio of interval D1, and the similarities are not repeated here. The length of the film 200 increases after passing through the interval D1, the film 200 is narrowed at the same time, that is, the width of the film 200 in a direction of y-axis of FIG. 1 is decreased. The decrease in width of the film 200 makes the usable area smaller and the utilization rate deteriorated. To resolve the above problem, the narrowing in the width of the film 200 is reduced by adjusting the ratio of the length of interval D1 to the length of interval D2 of the film 200.

In one embodiment, the length of interval D1 is smaller than the length of interval D2. In another embodiment, the ratio of the length of interval D1 to the length of interval D2 is approximately within the range of 1:1 to 1:8. In one more embodiment, the ratio of the length of interval D1 to the length of interval D2 equals 1:3. A measuring station 501 can position at a part of interval D1 closer to the upstream. In addition, a measuring station 502 can position at the part of interval D2 closer to the upstream. The measuring stations 501 and 502 measure the width of the film 200. It can change the lengths of intervals D1 and D2 by changing the positions of the rollers 121 and 121′, 122 and 122′ and 123 and 123′ on the film transferring path 125. In one embodiment, the number of sets of rollers can be various, such as 4 for dividing the film transferring path into three interval lengths. In some embodiments, the number of sets of rollers can be 5 or above.

In addition, the stretching bath 120 contains boric acid and potassium iodide. The stretching bath 120 stretches the film 200, the iodine molecules then enter the film 200 and are aligned inside the film 200. The boric acid used as a cross-linker crosslinks the iodine molecules with the film 200 in the stretching bath 120. In one embodiment, the content of potassium iodide in the stretching bath 120 is within the range of 0.05% to 30% by weight. In another embodiment, the content of potassium iodide in the stretching bath 120 is within the range of 1% to 15% by weigh. In one more embodiment, the content of potassium iodide in the stretching bath 120 is within the range of 5% to 10% by weight. In one embodiment, the content of boric acid used as a cross-linker in the stretching bath 120 is within the range of 0.05% to 30% by weight. In another embodiment, the content of boric acid is within the range of 1% to 15% by weight. In one more embodiment, the content of boric acid is within the range of 5% to 10% by weight. In one embodiment, the temperature in the stretching bath 120 is within the range of 10° C. to 80° C. In another embodiment, the temperature in the stretching bath 120 is within the range of 20° C. to 70° C. In one more embodiment, the temperature in the stretching bath 120 is within the range of 35° C. to 60° C. In the practical application, the contents of boric acid, the contents of potassium iodide and the temperature in the stretching bath 120 can be adjusted according to actual needs in the manufacturing process.

The post-processing module 130 includes a crosslinking bath 131, a washing bath 132, two ovens 133 and 135, a film attaching assembly 134 and a winding device 136. The film attaching assembly 134 includes protection layer feeding rollers 134a and 134b. The crosslinking bath 131 of the post-processing module 130 contains boric acid and potassium iodide, and receives the film 200 transferred from the stretching bath 120. The film is cross-linked in the crosslinking bath 131 containing the boric acid and potassium iodide. The temperature in the crosslinking bath 131 is lower than the temperature in the stretching bath 120. Because of the lower temperature in the crosslinking bath 131, a tension of the film 200 gradually decreases after the film 200 enters the crosslinking bath 131. The content of potassium iodide in the crosslinking bath 131 is within the range of 0.05% to 30% by weight. In one embodiment, the content of potassium iodide in the crosslinking bath 131 is within the range of 1% to 15% by weight. In another embodiment, the content of potassium iodide in the crosslinking bath 131 is within the range of 5% to 10% by weight. Furthermore, the content of boric acid, used as a cross-linker, in the crosslinking bath 131 is within the range of 0.05% to 30% by weight. In one embodiment, the content of boric acid in the crosslinking bath 131 is within the range of 1% to 15% by weight. In another embodiment, the content of boric acid in the crosslinking bath 131 is within the range of 5% to 10% by weight. In addition, the temperature in the crosslinking bath 131 is within the range of 10° C. to 35° C. In another embodiment, the temperature in the crosslinking bath 131 is within the range of 15° C. to 30° C. In one more embodiment, the temperature in the crosslinking bath 131 is within the range of 20° C. to 25° C.

The washing bath 132 of the post-processing module 130 contains water, and the washing bath 132 receives the film 200 transferred from the crosslinking bath 131. In addition, the washing bath 132 washes the boric acid off the surface of the film 200. The oven 133 of the post-processing module 130 receives the film 200 transferred from the washing bath 132. The oven 133 can reduce the water content of the film 200. In one embodiment, the temperature in the oven 133 is within the range of 30° C. to 120° C. In another embodiment, the temperature in the oven 133 is within the range of 50° C. to 100° C. In one more embodiment, the temperature in the oven 133 is within the range of 60° C. to 80° C. A measuring station 503 can position at the rear of the oven 133 for measuring the width of the film 200.

The film attaching assembly 134 of the post-processing module 130 receives the film 200 transferred from the oven 133. The film attaching assembly 134 includes protection layer feeding rollers 134a and 134b respectively disposed on two sides of the film 200 for attaching a protection layer on the film 200. Other materials, such as the materials possessing optical properties, can also be attached on the film 200 to fit the user's needs.

The oven 135 of the post-processing module 130 receives the film 200 transferred from the film attaching assembly 134. The oven 135 cures the transferred film 200 and reduces the water content of the transferred film 200 by heat, the protection layer can be firmly attached on the transferred film 200. In one embodiment, the temperature in the oven 135 is in the range of 40° C. to 120° C. In another embodiment, the temperature in the oven 135 is in the range of 50° C. to 100° C. In one more embodiment, the temperature in the oven 135 is in the range of 65° C. to 80° C. The winding device 136 receives the film 200 transferred from oven 135 for winding the film 200.

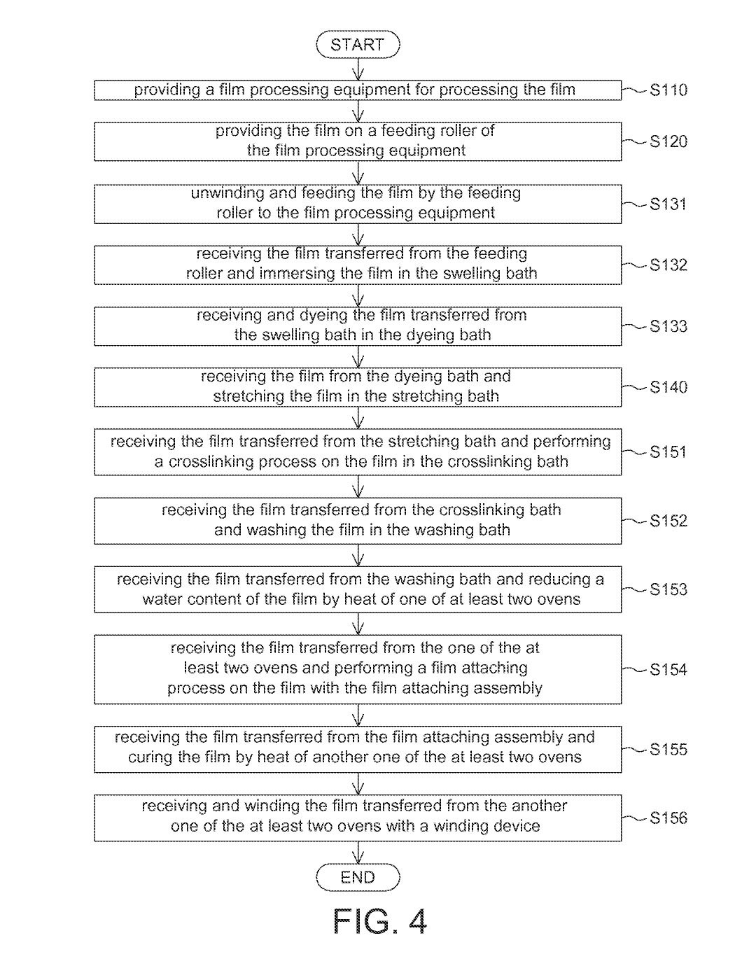

The descriptions of the elements disclosed above are elaborated below with an accompanying flowchart. However, the flowchart is not limited to be used in the above elements. FIG. 4 is a flowchart illustrating one embodiment of a method for processing the film 200 using the film processing equipment 100. First, as shown in step S110, the film processing equipment 100 is provided for processing the film 200. The film processing equipment 100 includes the stretching bath 120, the pre-processing module 110 disposed in front of the stretching bath 120, and the post-processing module 130 disposed at the rear of the stretching bath 120 is provided. The pre-processing module 110 includes the feeding roller 111, the swelling bath 112 and the dyeing bath 113. In addition, the post-processing module 130 includes the crosslinking bath 131, the washing bath 132, the two ovens 133 and 135, the film attaching assembly 134 and the winding device 136.

In step S120, the film 200 is provided on the feeding roller 111 of the film processing equipment 100.

In step S131, the feeding roller 111 unwinds the film 200 and feeds the film 200 to the film processing equipment 100.

In step S132, the swelling bath 112 receives the film 200 transferred from the feeding roller 111 and immerses the film 200.

In step S133, the dyeing bath 113 receives and dyes the film 200 transferred from the swelling bath 112.

In step S140, the stretching bath 120 receives the film 200 from the dyeing bath 113 and stretches the film 200. The stretching bath 120 includes plural sets of rollers disposed at different positions on the film transferred path 125 in the stretching bath 120. The positions of the rollers divide the overall length of the film transferred path 125 into several intervals, and at least two lengths of intervals are different. In one embodiment, the positions of the rollers divide the overall length of the film transferred path 125 into two interval lengths, wherein the interval length closer to the pre-processing module (a second interval length) is smaller than the interval length closer to the post-processing module (a second interval length). For example, the ratio of the first interval length to the second interval length is within the range of 1:1 to 1:8. For one more example, the ratio of the first interval length to the second interval length is equals 1:3.

In step S151, the crosslinking bath 131 receives the film 200 transferred from the stretching bath 120 and performs a crosslinking process on the film 200. The crosslinking process is generally performed using a boron compound. The boron compound may be boric acid, borax or the like.

In step S152, the washing bath 132 receives the film 200 transferred from the crosslinking bath 131 and washes the transferred film 200.

In step S153, the oven 133 receives the film 200 transferred from the washing bath 132 and reduces a water content of the film 200 by heat.

In step S154, the film attaching assembly 134 receives the film 200 transferred from the oven 133 and performs a film attaching process on the film 200. In one embodiment, the film attaching assembly 134 performs the film attaching process on at least a surface of the film. The film attaching process is used an adhesive agent coating on the film 200 transferred from the oven 133. For example, the adhesive agent is selected from a thermosetting adhesive agent.

In step S155, the oven 135 receives the film 200 transferred from the film attaching assembly 134 and cures the film 200 by heat.

In step S156, the winding device 136 receives and winds the film 200 transferred from the oven 135.

Experiments related to the intervals of the rollers on film transferring path 125 of the stretching bath 120 are performed and the film formation widths are measured.

### Comparison Example 1

In one embodiment, the film 200 is a PVA film. The PVA film whose polymerization degree equals 2800 and saponification degree is larger than 99.99%. The feeding roller 111 feeds the PVA film to the swelling bath 112. The swelling bath 112 immerses and moisturizes the PVA film and the dyeing bath 113 dyes the PVA film. For example, the dyeing bath 113 contains 0.2% of iodine by weight, 10% of potassium iodide by weight and 2.4% of boric acid by weight. The temperature in the dyeing bath 113 is 35° C. and a dyeing time is 1 minute. The PVA film is then transferred to the stretching bath 120. Wherein, the ratio of the length of interval D1 to the length of interval D2 on the film transferring path 125 equals 1:1. The stretching bath 120 contains 5% of potassium iodide by weight and 8% of boric acid by weight. In addition, the temperature in the stretching bath 120 is 50° C. and a processing time of the PVA film in the stretching bath 120 is 5 minutes. The drawing ratio of interval D1 is 1.47 and the drawing ratio of interval D2 is 1.39. The widths of the PVA film measured by the measuring stations 501 and 502 are respectively defined as the film width of incoming interval D1 and the film width of outgoing interval D1. Then, the PVA film is processed in the crosslinking bath 131 which contains 6% of potassium iodide by weight and 6% of boric acid by weight. The temperature in the crosslinking bath 131 is 25° C. Then, after the PVA film is baked and dried in the oven 133 at the temperature of 70° C., a polarizing film is obtained, and the width of the PVA film measured by the measuring station 503 is read and defined as film formation width. The results of width measurement are illustrated in Table 1.

### Comparison Example 2

In some embodiment, the PVA film whose polymerization degree equals 2800 and saponification degree is larger than 99.99%. The feeding roller 111 feeds the PVA film to the swelling bath 112. The swelling bath 112 immerses and moisturizes the PVA film and the dyeing bath 113 dyes the PVA film. For example, the dyeing bath 113 contains 0.2% of iodine by weight, 10% of potassium iodide by weight and 2.4% of boric acid by weight. The temperature in the dyeing bath 113 is 35° C. and a dyeing time is 1 minute. The PVA film is then transferred to the stretching bath 120. Wherein, the ratio of the length of interval D1 to the length of interval D2 on the film transferring path 125 equals 1:1. The stretching bath 120 contains 5% of potassium iodide by weight and 8% of boric acid by weight. In addition, the temperature in the stretching bath 120 is 50° C. and a processing time of the PVA film in the stretching bath 120 is 5 minutes. The drawing ratio of interval D1 is 2.21 and the drawing ratio of interval D2 is 1.39. The widths of the PVA film measured by the measuring stations 501 and 502 are respectively defined as the film width of incoming interval D1 and the film width of outgoing interval D1. Then, the PVA film is processed in the crosslinking bath 131 which contains 6% of potassium iodide by weight and 6% of boric acid by weight. The temperature in the crosslinking bath 131 is 25° C. Then, after the PVA film is baked and dried in the oven 133 at the temperature of 70° C., a polarizing film is obtained, and the width of the PVA film measured by the measuring station 503 is read and defined as film formation width. The results of width measurement are illustrated in Table 1.

### Embodiment 1

In some embodiment, the PVA film whose polymerization degree equals 2800 and saponification degree is larger than 99.99%. The feeding roller 111 feeds the PVA film to the swelling bath 112. The swelling bath 112 immerses and moisturizes the PVA film, and the dyeing bath 113 dyes the PVA film. For examples, the dyeing bath 113 contains 0.2% of iodine by weight, 10% of potassium iodide by weight and 2.4% of boric acid by weight. The temperature in the dyeing bath 113 is 35° C. and a dyeing time is 1 minute. The PVA film is then transferred to the stretching bath 120. Wherein, the ratio of the length of interval D1 to the length of interval D2 on the film transferring path 125 equals 1:3. The stretching bath 120 contains 5% of potassium iodide by weight and 8% of boric acid by weight. In addition, the temperature in the stretching bath 120 is 50° C. and the processing time of the PVA film in the stretching bath 120 is 5 minutes. The drawing ratio of interval D1 is 1.47 and the drawing ratio of interval D2 is 1.39. The widths of the PVA film measured by the measuring stations 501 and 502 are respectively defined as the film width of incoming interval D1 and the film width of outgoing interval D1. Then, the PVA film is processed in the crosslinking bath 131 which contains 6% of potassium iodide by weight and 6% of boric acid by weight. The temperature in the crosslinking bath 131 is 25° C. Then, after the PVA film is baked and dried in the oven 133 at the temperature of 70° C., a polarizing film is obtained, and the width of the PVA film measured by the measuring station 503 is read and defined as film formation width. The results of width measurement are illustrated in Table 1.

### Embodiment 2

In some embodiment, the PVA film whose polymerization degree equals 2800 and saponification degree is larger than 99.99%. The feeding roller 111 feeds the PVA film to the swelling bath 112. The swelling bath 112 immerses and moisturizes the PVA film and the dyeing bath 113 dyes the PVA film. For example, the dyeing bath 113 contains 0.2% of iodine by weight, 10% of potassium iodide by weight and 2.4% of boric acid by weight. The temperature in the dyeing bath 113 is 35° C. and a dyeing time is 1 minute. The PVA film is then transferred to the stretching bath 120. Wherein, the ratio of the length of interval D1 to the length of interval D2 on the film transferring path 125 equals 1:3. The stretching bath 120 contains 5% of potassium iodide by weight and 8% of boric acid by weight. In addition, the temperature in the stretching bath 120 is 50° C. and a processing time of the PVA film in the stretching bath 120 is 5 minutes. The drawing ratio of interval D1 is 2.21 and the drawing ratio of interval D2 is 1.39. The widths of the PVA film measured by the measuring stations 501 and 502 are respectively defined as the film width of incoming interval D1 and the film width of outgoing interval D1. Then, the PVA film is processed in the crosslinking bath 131 which contains 6% of potassium iodide by weight and 6% of boric acid by weight. The temperature in the crosslinking bath 131 is 25° C. Then, after the PVA film is baked and dried in the oven 133 at the temperature of 70° C., a polarizing film is obtained, and the width of the PVA film measured by the measuring station 503 is read and defined as film formation width. The results of width measurement are illustrated in Table 1.

TABLE 1

| | Comparison | Comparison | Embodi- | Embodi- |
|---|---|---|---|---|
| | Example 1 | Example 2 | ment 1 | ment 2 |
| The length of | 1:1 | 1:1 | 1:3 | 1:3 |
| interval D1:the | | | | |
| length of | | | | |
| interval D2 | | | | |
| The drawing ratio of | 1.47 | 2.21 | 1.47 | 2.21 |
| interval D1 | | | | |
| The length (mm) of | 840 | 840 | 420 | 420 |
| interval D1 | | | | |
| The film width | 581 | 591 | 581 | 591 |
| (mm) of the | | | | |
| incoming | | | | |
| interval D1 | | | | |
| The film width | 470 | 483 | 478 | 496 |
| (mm) of the | | | | |
| outgoing | | | | |
| interval D1 | | | | |
| The film width | −111 | −108 | −103 | −95 |
| (mm) of outgoing | | | | |
| interval D1 − the | | | | |
| film width (mm) | | | | |
| of incoming | | | | |
| interval D1 | | | | |
| The film formation | 341 | 327 | 368 | 361 |
| width (mm) | | | | |

With the exception of the ratio of the length of interval D1 to the length of interval D2, the conditions of comparison example 1 and embodiment 1 of Table 1 are the same. For example, the drawing ratio of interval D1 in the comparison example 1 and embodiment 1 are both 1.47. The ratio of the length of interval D1 to the length of interval D2 equals 1:1 in comparison example 1 but equals 1:3 in embodiment 1. In comparison example 1, a difference of the width of outgoing interval D1 deducted by the width of incoming interval D1 equals −111 mm. In embodiment 1, the difference of the width of outgoing interval D1 deducted by the width of incoming interval D1 equals −103 mm and is 8 mm better than that in comparison example 1. Furthermore, the film formation width which equals 341 mm in comparison example 1. In embodiment 1, the film formation width equals 368 mm and is 27 mm wider than that in comparison example 1. In comparison to the comparison example 1, the usable area of the PVA film is largely increased in the embodiment 1.

Similarly, with the exception of the ratio of the length of interval D1 to the length of interval D2, the conditions of comparison example 2 and embodiment 2 of Table 1 are the same. For example, the drawing ratio of interval D1 in the comparison example 1 and embodiment 1 are both 2.21. The ratio of the length of interval D1 to the length of interval D2 equals 1:1 in comparison example 2 but equals 1:3 in embodiment 2. In comparison example 2, a difference of the width of outgoing interval D1 deducted by the width of incoming interval D1 equals −108 mm. In embodiment 2, the difference of the width of outgoing interval D1 deducted by the width of incoming interval D1 equals −95 mm and is 13 mm better than that in comparison example 2. Furthermore, the film formation width which equals 327 mm in comparison example 2. In embodiment 2, the film formation width equals 361 mm and is 34 mm wider than in comparison example 1. In comparison to the comparison example 2, the usable area of the PVA film is largely increased in the embodiment 2.

To summarize, regardless the drawing ratio of interval D1 is 1.47 or 2.21, the film formation width obtained if the ratio of the length of interval D1 to the length of interval D2 equals 1:3 is wider than that obtained if the ratio of the length of interval D1 to the length of interval D2 equals 1:1. The film formation width in embodiment 1 is 7.33% wider than the film formation width in comparison example 1. The film formation width in embodiment 2 is 10.39% wider than the film formation width in comparison example 2. Thus, if the ratio of the length of interval D1 to the length of interval D2 equals 1:3, the degree of neck-in is reduced during the manufacturing of the PVA film and the usable area of the PVA film can be largely increased.

### Second Embodiment

Referring to FIG. 2, the present embodiment of the disclosure is different from the first embodiment in that the temperature in the stretching bath 120. In the second embodiment, the temperature of the stretching bath 120 is set to be within the range of 55° C. to 65° C. for stretching the film 200. The temperature in the crosslinking bath 131 of the post-processing module 130 is set to be within the range of 50° C. to 60° C. for performing the crosslinking process. The temperatures in the stretching bath 120 and the crosslinking bath 131 of the second embodiment are higher than the temperatures in the stretching bath 120 and the crosslinking bath 131 of the first embodiment. The increased temperatures of the crosslinking bath 131 and the stretching bath 120 reduce a possibility of film breakage during the manufacturing process. Furthermore, the cross-linking process is completed in the wet process because of the increased temperatures of the crosslinking bath 131 and the stretching bath 120. It makes no more contraction if temperature is increased in subsequent process. Thus, the contraction value of the film becomes smaller, that is, the size stability of the film is increased. The term “contraction value” refers to the displacement caused by the contraction in the length of the manufactured film 200 in the direction of the x-axis of FIG. 1, and the displacement of contraction is measured by a size stability quantitative instrument before and after the temperature is increased.

Experiments related to increasing the temperatures in the stretching bath 120 and the crosslinking bath 131 are performed, the impact on experimental results when the rollers are disposed in the stretching bath 120 at different intervals are observed, and the contraction value of the film formation is measured.

### Comparison Example 3

In one embodiment, the PVA film whose polymerization degree equals 2800 and saponification degree is larger than 99.99%. The feeding roller 111 feeds the PVA film to the swelling bath 112. The swelling bath 112 immerses and moisturizes the PVA film and the dyeing bath 113 dyes the PVA film. For example, the dyeing bath 113 contains 0.2% of iodine by weight, 10% of potassium iodide by weight and 2.4% of boric acid by weight. The temperature in the dyeing bath 113 is 35° C. and a dyeing time is 1 minute. The PVA film is then transferred to the stretching bath 120. Wherein, the ratio of the length of interval D1 to the length of interval D2 on the film transferring path 125 equals 1:1. The stretching bath 120 contains 5% of potassium iodide by weight and 8% of boric acid by weight. In addition, the temperature in the stretching bath 120 is 50° C. and a processing time of the PVA film in the stretching bath 120 is 5 minutes. The drawing ratio of interval D1 is 2.21 and the drawing ratio of interval D2 is 1.39. Then, the PVA film is processed in the crosslinking bath 131 which contains 6% of potassium iodide by weight and 6 of boric acid by weight. The temperature in the crosslinking bath 131 is 35° C. After the PVA film is baked and dried in the oven 133 at the temperature of 70° C. and filmed by the film attaching assembly 134, the PVA film again enters the oven 135 at the temperature of 40° C.-90° C., then a polarizing film is obtained. The contraction value of the polarizing film is measured by the size stability quantitative instrument.

The size stability quantitative instruments can be realized by such as a TA-Q400 thermal mechanical analyzer (TMA) with the following specifications: film length is 240 mm (the moving direction of the film is the direction of x-axis of FIG. 1), film width is 4.5 mm (the direction of y-axis of FIG. 1), and film thickness is 75 μm (the direction of z-axis of FIG. 1). As for the testing conditions, the pulling force is set as 0.5 Newton (N), the temperature starts with the room temperature, then the temperature is increased to 85° C. at a rate of 10° C. per minute, and then stays at 85° C. for 30 minutes.

### Comparison Example 4

In some embodiment, the PVA film whose polymerization degree equals 2800 and saponification degree is larger than 99.99%. The feeding roller 111 feeds the PVA film to the swelling bath 112. The swelling bath 112 immerses and moisturizes the PVA film and the dyeing bath 113 dyes the PVA film. For example, the dyeing bath 113 contains 0.2% of iodine by weight, 10% of potassium iodide by weight and 0.8% of boric acid by weight. The temperature in the dyeing bath 113 is 35° C. and a dyeing time is 1 minute. The PVA film is then transferred to the stretching bath 120. Wherein, the ratio of the length of interval D1 to the length of interval D2 on the film transferring path 125 equals 1:1. The stretching bath 120 contains 5% of potassium iodide by weight and 8% of boric acid by weight. In addition, the temperature in the stretching bath 120 is 56° C. and a processing time of the PVA film in the stretching bath 120 is 5 minutes. The drawing ratio of interval D1 is 2.21 and the drawing ratio of interval D2 is 1.39. Then, the PVA film is processed in the crosslinking bath 131 which contains 6% of potassium iodide by weight and 6% of boric acid by weight. The temperature in the crosslinking bath 131 is 50° C. After the PVA film is baked and dried in the oven 133 at the temperature of 70° C. and filmed by the film attaching assembly 134, the PVA film again enters the oven 135 at the temperature of 40° C. to 90° C., then a polarizing film is obtained. The contraction value of the polarizing film is measured by the size stability quantitative instrument. The specifications of the film used by a size stability quantitative instrument are the same with that used in comparison example 3, and the similarities are not repeated here.

### Embodiment 3

In some embodiment, the PVA film whose polymerization degree equals 2800 and saponification degree is larger than 99.99%. The feeding roller 111 feeds the PVA film to the swelling bath 112. The swelling bath 112 immerses and moisturizes the PVA film and the dyeing bath 113 dyes the PVA film. For example, the dyeing bath 113 contains 0.2% of iodine by weight, 10% of potassium iodide by weight and 0.8% of boric acid by weight. The temperature in the dyeing bath 113 is 35° C. and a dyeing time is 1 minute. The PVA film is then transferred to the stretching bath 120. Wherein, the ratio of the length of interval D1 to the length of interval D2 on the film transferring path 125 equals 1:3. The stretching bath 120 contains 5% of potassium iodide by weight and 8% of boric acid by weight. In addition, the temperature in the stretching bath 120 is 56° C. and a processing time of the PVA film in the stretching bath 120 is 5 minutes. The drawing ratio of interval D1 is 2.21 and the drawing ratio of interval D2 is 1.39. Then, the PVA film is processed in the crosslinking bath 131 which contains 6% of potassium iodide by weight and 6% of boric acid by weight. The temperature in the crosslinking bath 131 is 50° C. After the PVA film is baked and dried in the oven 133 at the temperature of 70° C. and filmed by the film attaching assembly 134, the PVA film again enters the oven 135 at the temperature of 40° C. to 90° C., then a polarizing film is obtained. The contraction value of the polarizing film is measured by the size stability quantitative instrument. The specifications of the film used by a size stability quantitative instrument are the same with that used in comparison example 3, and the similarities are not repeated here.

TABLE 2

| | Comparison | Comparison | Embodi- |
|---|---|---|---|
| | Example 3 | Example 4 | ment 3 |
| The length of interval D1:the | 1:1 | 1:1 | 1:3 |
| length of interval D2 | | | |
| The length (mm) of interval D1 | 840 | 840 | 420 |
| The stretching bath | 50 | 56 | 56 |
| temperature ( ) | | | |
| The boric acid in dyeing bath (% | 2.4 | 0.8 | 0.8 |
| by weight) | | | |
| The crosslinking bath | 35 | 50 | 50 |
| temperature ( ) | | | |
| The contraction value (μm) | −85 | −51 | −39 |

As shown in Table 2, the comparison example 3 is different from the comparison example 4 in that, the temperature in the stretching bath 120 is in the comparison example 3 but is 56 in the comparison example 4, the dyeing bath 113 contains 2.4% of boric acid by weight in the comparison example 3 but is 0.8% in the comparison example 4, the temperature in the crosslinking bath 131 is 35 in the comparison example 3 but is 50 in the comparison example 4. And comparison examples 3 and 4 show no difference in terms of other conditions (for example, the ratio of the length of interval D1 to the length of interval D2 equals 1:1). After the above settings of conditions, the contraction value of the PVA film is −85 μm in the comparison example 3 but is −51 μm in the comparison example 4 (high-temperature stretching bath+high-temperature crosslinking bath).

Furthermore, With the exception of the ratio of the length of interval D1 to the length of interval D2 equals 1:3 in the embodiment 3 but equals 1:1 in the comparison example 4, the conditions of the embodiment 3 and the comparison example 4 of Table 2 are the same. Thus, the contraction value of PVA film is improved to −39 um in the embodiment 3. A comparison between the embodiment 3 and the comparison example 3 shows if the temperature in the stretching bath 120 and the temperature in the crosslinking bath 131 increase and the ratio of the length of interval D1 to the length of interval D2 is appropriately adjusted as 1:3, the contraction value of the PVA film can be improved by about 50%, and size stability of the film is largely increased.

As disclosed in the embodiments of the disclosure, the positions of the rollers divide the film transferring path 125 into suitable intervals, so that as the film 200 is stretched and the degree of neck-in of the film 200 is decreased. In addition, the usable area and utilization rate of the film 200 are increased, and the manufacturing costs are reduced. Furthermore, the increased temperatures of the crosslinking bath 131 and the stretching bath 120 reduce a possibility of film breakage during the manufacturing process.

While the disclosure has been described by way of examples and in terms of the preferred embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A film processing equipment, comprising:
at least two ovens;
a feeding roller used for feeding a film;
a swelling bath used for receiving and immersing the film transferred from the feeding roller;
a dyeing bath used for receiving and dyeing the film transferred from the swelling bath;
a stretching bath for receiving and stretching the film transferred from the dyeing bath;
a crosslinking bath used for receiving the film transferred from the stretching bath and crosslinking the film in the crosslinking bath;
a washing bath used for receiving and washing the film transferred from the crosslinking bath;
a film attaching assembly used for receiving the film transferred from one of the ovens and performing a film attaching process on the film; and
a winding device used for winding the film;
wherein the stretching bath comprises a plurality of sets of rollers disposed at different positions on a film transferred path in the stretching bath, the sets of rollers divide the film transferring path into a first interval length and a second interval length; and
wherein the first interval length is in an upstream with respect to the film transferring path, the second interval length is in the downstream with respect to the film transferring path, and the first interval length is smaller than the second interval length.

2. The film processing equipment as claimed in claim 1, wherein the film is a polyvinyl alcohol (PVA) film.

3. The film processing equipment as claimed in claim 1, wherein the number of the sets of rollers is three.

4. The film processing equipment as claimed in claim 1, wherein a ratio of the first interval length to the second interval length is within the range of 1:1 to 1:8.

5. The film processing equipment as claimed in claim 1, wherein the ratio of the first interval length to the second interval length is 1:3.

6. The film processing equipment as claimed in claim 1, wherein a temperature in the stretching bath is set between a range of 55° C. to 65° C.

7. The film processing equipment as claimed in claim 1, wherein the temperature in the crosslinking bath is set between the range of 50° C. to 60° C.

8. A method for processing a film, comprising:
providing a film processing equipment comprising a feeding roller, a swelling bath, a dyeing bath, a stretching bath, a crosslinking bath, a washing bath, a film attaching assembly, at least two ovens and a winding device;
providing the film on the feeding roller and feeding the film from the feeding roller;
receiving the film transferred from the feeding roller and immersing the film in the swelling bath;
receiving the film transferred from the swelling bath and dyeing the film in the dyeing bath;
receiving the film transferred from the dyeing bath and stretching the film in the stretching bath;
receiving the film transferred from the stretching bath and performing a crosslinking process on the film in the crosslinking bath;
receiving the film transferred from the crosslinking bath and washing the film in the washing bath;
receiving the film transferred from the washing bath and reducing a water content of the film by heat with one of the ovens;
receiving the film transferred from the one of the ovens and performing a film attaching process on the film with the film attaching assembly;
receiving the film transferred from the film attaching assembly and curing the film by heat with another one of the ovens different from the one used after the washing bath; and
winding the film with the winding device;
wherein the stretching bath comprises a plurality of sets of rollers disposed at different positions on a film transferred path in the stretching bath, the sets of rollers divide the film transferring path into a first interval length and a second interval length, and
wherein the first interval length is in an upstream with respect to the film transferring path, the second interval length is in the downstream with respect to the film transferring path, and the first interval length is smaller than the second interval length.

9. The method as claimed in claim 8, wherein the number of the sets of rollers is three.

10. The method as claimed in claim 8, wherein a ratio of the first interval length to the second interval length ranges between 1:1 and 1:8.

11. The method as claimed in claim 8, wherein the ratio of the first interval length to the second interval length is 1:3.

12. The method as claimed in claim 8, wherein a temperature in the stretching bath is set between a range of 55° C. to 65° C.

13. The method as claimed in claim 8, wherein the temperature in the crosslinking bath is set between the range of 50° C. to 60° C.

14. The method as claimed in claim 8, wherein the film is a polyvinyl alcohol (PVA) film.
